(19) United States
(12) Patent Application Publication
(10) Pub. No.: US 2009/0104055 A1
(43) Pub. Date: Apr. 23, 2009

(54) ELECTRIC COMPRESSOR MANUFACTURING METHOD AND ELECTRIC COMPRESSOR

(75) Inventors: Yutaka SATOU, Kitakatsushika-gun (JP); Hiroki Yasuda, Kitamoto-shi (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 12/253,609

(22) Filed: Oct. 17, 2008

(30) Foreign Application Priority Data
Oct. 18, 2007 (JP) 2007-271605

(51) Int. Cl. F04B 35/04; B23P 15/00

(52) U.S. Cl. 417/410.1; 29/888.02

(57) ABSTRACT

The present invention aims to achieve a simplest possible transfer of components in an assembling process while almost perfectly preventing dirt, oil and the like from producing an adverse effect on a motor control circuit. A compressor main body assembly A is assembled by fitting, to a rear housing member 3 and a middle housing member 4, a compression mechanism 10 configured to compress a coolant, and an electric motor 20 configured to drive the compression mechanism 10. The motor controller assembly B is assembled by mounting a motor controlling circuit 40 to a second housing member 5 so that the motor controlling circuit 40 can be in a hermetic state. Here, the motor controlling circuit 40 is configured to control a drive of the electric motor 20. Then, the compressor main body assembly A and the motor controller assembly B are combined together.

### BACKGROUND OF THE INVENTION

1. Field of the Invention

The present invention relates to a method of manufacturing an electric compressor equipped with an electric motor configured to drive a compression mechanism and a motor controlling circuit configured to control the drive of the electric motor. The present invention also relates to an electric compressor manufactured with the manufacturing method.

2. Description of the Related Art

A conventional type of electric compressor equipped with an electric motor and a motor controlling circuit has been disclosed in Japanese Patent Application Laid-Open No. 2003-214340. As shown in FIG. 1, the electric compressor 100 disclosed in this patent document includes a housing 101. The housing 101 includes a rear housing member 102, a middle housing member 103 and a front housing member 104. The rear housing member 102 has a cylindrical shape with one side thereof closed and the other side thereof opened. The middle housing member 103 also has a cylindrical shape and is arranged with its one side located at the opened side of the rear housing member 102. The front housing member 104 is arranged to close the other opened side of the middle housing member 103.

The housing 101 includes a compression mechanism 110 configured to compress a coolant and an electric motor 111 configured to drive the compression mechanism 110. The rear housing member 102 is provided with a hermetic terminal 112 through which a drive signal is inputted into the electric motor 111. The hermetic terminal 112 protrudes into a motor controller compartment 121 in a motor controller housing 120, which will be described later.

In addition, the motor controller housing 120 is integrally provided to the front housing member 104. The motor controller compartment 121 is provided in the motor controller housing 120. The motor controller compartment 121 is provided with a motor controlling circuit 122 configured to generate a drive signal for the electric motor 111. The motor controlling circuit 122 constitutes an inverter circuit, and mainly includes a board supporting case 123, a ceramic board 124, a printed board 125 and a controller-side terminal 126. The ceramic board 124 and the printed board 125 each mounting electronic parts thereon are supported by the board supporting case 123. The controller-side terminal 126 is used to output the drive signal. The hermetic terminal 112 is inserted into and thus is connected to the controller-side terminal 126. The motor controller compartment 121 is closed with a cover 127.

A sequence for manufacturing the electric compressor 100 is as follows. Firstly, chief parts for the electric motor 111 and the compression mechanism 110 as well as the hermetic terminal 112 are fitted to the rear housing member 102 and the middle housing member 103. Subsequently, the front housing member 104 is fitted to the resultant assembly. In this way, in the electric compressor 100, the housing 101 is fixed as a single unit and the compression mechanism 110 is also fixed.

After assembling the mechanical component parts, the motor controlling circuit 122 is mounted in the motor controller compartment 121 in the motor controller housing 120. The hermetic terminal 112 is inserted into and thus is connected to the controller-side terminal 126 during the mounting operation of the motor controlling circuit 122. Finally, the motor controller compartment 121 in the motor controller housing 120 is closed with the cover 127.

In the process for manufacturing the electric compressor 100, the assembling operation of the mechanical components such as the compression mechanism 110 uses oils and the like, and does not cause a serious adverse effect when dirt, oil and the like enter the mechanical components. For this reason, it does not matter that the mechanical components are assembled in an environment in which there are some dirt, oil and the like. In contrast, the electric components such as the motor controlling circuit 122 needs to be mounted to the housing 101 in an environment free from dirt, oil or the like, where the entry of the dirt, oil or the like is prevented in order to avoid an adverse effect such as short-circuit.

In the conventional method of manufacturing the electric compressor 100, the compression mechanism 110 and the electric motor 111 are fitted in the housing 101, and thereafter the motor controlling circuit 122 is mounted to the resultant housing 101. For this reason, for the purpose of preventing the motor controlling circuit 122 from being adversely affected by dirt, oil and the like, the housing 101 already having the compression mechanism 110 and the electric motor 111 fitted therein needs to be transferred to an environment free from dirt, oil and the like, for example, to a clean room before the motor controlling circuit 122 is mounted to the housing 101.

In addition, when the compression mechanism 110 and the electric motor 111 are fitted in the housing 101, the motor controller compartment 121 in the motor controller housing 120 is opened. For this reason, dirt, oil and the like are highly likely to be attached to the inside of the motor controller compartment 121. As a result, even if the motor controlling circuit 122 is mounted to the housing 101 in an environment free from dirt, oil and the like, for example, in a clean room, it is not possible to perfectly eliminate the risk that the motor controlling circuit 122 may be adversely affected by dirt, oil and the like.

### SUMMARY OF THE INVENTION

The present invention has been achieved with such points in mind.

It therefore is an object of the present invention to provide an electric compressor manufacturing method which is capable of achieving a simplest possible component transfer during its assembling process, and of almost perfectly preventing a motor controlling circuit from being adversely affected by dirt, oil and the like, and is to provide an electric compressor thus manufactured.

To achieve the object, according to a first aspect of the present invention, there is provided an electric compressor manufacturing method characterized by including the steps of: assembling a compressor main body assembly (A) by fitting, to a first housing member (3), (4), a compression mechanism (10) configured to compress a coolant, and an electric motor (20) configured to drive the compression mechanism (10); assembling a motor controller assembly (B) by mounting a motor controlling circuit (40) to a second housing member (5) so that the motor controlling circuit (40) is in a hermetic state, the motor controlling circuit (40) configured to control a drive of the electric motor (20); and combining the compressor main body assembly (A) and the motor controller assembly (B) together.

In the first aspect of the present invention, the compressor main body assembly and the motor controller assembly can be separately mounted in the assembling process of the electric compressor, and dirt, oil or the like may enter the motor controller compartment only in the assembling step of the motor controller assembly. Once the motor controller assembly is assembled, the motor controller compartment is hermetically sealed so that no dirt, oil or the like can enter. For this reason, if only the motor controller assembly is assembled in an environment free from dirt, oil or the like, the dirt, oil and the like are almost completely prevented from causing failures from occurring in the motor controlling circuit. Furthermore, since components needed to assemble the motor controller assembly are the second housing member that is a part of the housing and the components of the motor controlling circuit, only these components should be transferred to an environment free from dirt, oil or the like. After being assembled, the motor controller assembly can be transferred to the assembling position of the compressor main body assembly. Thereby, the component transfer in the assembling process can be made as simple as possible, and concurrently the motor controlling circuit is almost perfectly prevented from being adversely affected by dirt, oil and the like.

Moreover, it goes without saying that the first aspect thereof enables the performance test of the motor controlling circuit not only when the electric compressor is assembled, but also when the motor controller assembly is assembled as a single unit. For this reason, the first aspect thereof is capable of enhancing manufacturing efficiency of the electric compressor.

A second aspect of the present invention is the electric compressor manufacturing method according to the first aspect thereof, characterized in that the second housing member (5) is a component constituting a housing (2) and configured to make the inside of the compressor (1) hermetic, and when the compressor main body assembly (A) and the motor controller assembly (B) are combined together, a coolant intake chamber (18b) is formed on a side of the second housing member (5) opposite to a side where the motor controlling circuit (40) is installed.

In addition to the effects of the first aspect of the present invention, the second aspect of the present invention is capable of cooling heat generated in the motor controlling circuit by use of the coolant flowing in the coolant intake chamber because the motor controlling circuit is adjacent to the coolant intake chamber with the second housing member being interposed in between.

A third aspect of the present invention is the electric compressor manufacturing method according to any one of the first and second aspects thereof, characterized in that in the compressor main body assembly (A) assembling step, a hermetic terminal (30) used to input a drive signal to the electric motor (20) is fitted in the first housing member (3), (4), in the motor controller assembly (B) assembling step, a controller-side terminal (45) used to output the drive signal from the motor controlling circuit (40) are mounted to the second housing member (5), and any one of the first housing member (3), (4) and the second housing member (5) is provided with a terminal accommodating chamber (46) which is opened to the outside through a working window (47), when the compressor main body assembly (A) and the motor controller assembly (B) are combined together, the hermetic terminal (30) and the controller-side terminals (45) are accommodated in the terminal accommodating chamber (46) and are connected together through the working window (47), and subsequently the working window (47) is closed with a cover (48).

In addition to the effects of the first and second aspects of the present invention, the third aspect of the present invention is capable of minimizing the risk that dirt, oil and the like may be attached to the hermetic terminal and the controller-side terminals during the operation of mounting the motor controller assembly to the compressor main body assembly because the hermetic terminal and the controller-side terminals are accommodated in the terminal accommodating chamber. Moreover, the third aspect thereof is capable of perfectly eliminating the risk that dirt, oil and the like may be attached to the hermetic terminal and the controller-side terminals after the compressor main body assembly and the motor controller are combined together because the working window of the terminal accommodating chamber is closed with the cover. Thereby, failures are prevented as much as possible from occurring due to dirt, oil and the like attached to the hermetic terminal and the controller-side terminals.

A fourth aspect of the present invention is the electric compressor manufacturing method according to any one of the first to third aspects thereof, characterized in that the hermetic terminal and the controller-side terminals are connected together by welding.

In addition to the effects of the first to third aspects of the present invention, the fourth aspect of the present invention is capable of firmly connecting the hermetic terminal and the controller-side terminals together to achieve high reliability connection.

A fifth aspect of the present invention is an electric compressor, characterized by including a compressor main body assembly (A) configured by fitting, to a first housing member (3), (4), a compression mechanism (10) configured to compress a coolant, and an electric motor (20) configured to drive the compression mechanism (10) and a motor controller assembly (B) configured by mounting a motor controlling circuit (40) to a second housing member (5) so that the motor controlling circuit (40) is in a hermetic state, the motor controlling circuit (40) configured to control a drive of the electric motor (20) wherein the compressor main body assembly (A) and the motor controller assembly (B) are combined together.

In the fifth aspect of the present invention, the compressor main body assembly and the motor controller assembly can be separately mounted in the assembling process of the electric compressor, and dirt, oil or the like may enter the motor controller compartment only in the assembling step of the motor controller assembly. Once the motor controller assembly is assembled, the motor controller compartment is hermetically sealed so that no dirt, oil or the like can enter. For this reason, if only the motor controller assembly is assembled in an environment free from dirt, oil or the like, the dirt, oil and the like are almost completely prevented from causing failures from occurring in the motor controlling circuit. Furthermore, since components needed to assemble the motor controller assembly are the second housing member that is a part of the housing and the components of the motor controlling circuit, only these components should be transferred to an environment free from dirt, oil or the like. After being assembled, the motor controller assembly can be transferred to the assembling position of the compressor main body assembly. Thereby, the component transfer in the assembling process can be made as simple as possible, and concurrently the motor controlling circuit is almost perfectly prevented from being adversely affected by dirt, oil and the like.

Moreover, it goes without saying that the fifth aspect thereof enables the performance test of the motor controlling circuit not only when the electric compressor is assembled, but also when the motor controller assembly is assembled as a single unit. For this reason, the fifth aspect thereof is capable of enhancing manufacturing efficiency of the electric compressor.

A sixth aspect of the present invention is the electric compressor according to the fifth aspect thereof, characterized in that the second housing member (5) is a component constituting a housing (2) and configured to make an inside of the electric compressor (1) hermetic, and a coolant intake chamber (18b) is formed on a side of the second housing member (5) opposite to a side where the motor controlling circuit (40) is mounted.

In addition to the effects of the fifth aspect of the present invention, the sixth aspect of the present invention is capable of cooling heat generated in the motor controlling circuit by use of the coolant flowing in the coolant intake chamber because the motor controlling circuit is adjacent to the coolant intake chamber with the second housing member being interposed in between.

A seventh aspect of the present invention is the electric compressor according to any one of the fifth and sixth aspects of thereof, characterized in that the compressor main body assembly (A) includes a hermetic terminal (30) used to input a drive signal to the electric motor (20), and fitted in the first housing member (3), (4), and the motor controller assembly (B) includes a controller-side terminal (45) used to output the drive signal from the motor controlling circuit (40) and mounted to the second housing member (5), and any one of the first housing member (3), (4) and the second housing member (5) is provided with a terminal accommodating compartment (46) in which the hermetic terminal (30) and the controller-side terminal (45) connected together are accommodated, and which is opened to an outside through a working window (47); and the working window (47) is closed with a cover (48).

In addition to the effects of the fifth and sixth aspects of the present invention, the seventh aspect of the present invention is capable of minimizing the risk that dirt, oil and the like may be attached to the hermetic terminal and the controller-side terminals during the operation of mounting the motor controller assembly to the compressor main body assembly because the hermetic terminal and the controller-side terminals are accommodated in the terminal accommodating chamber. Moreover, the seventh aspect thereof is capable of perfectly eliminating the risk that dirt, oil and the like may be attached to the hermetic terminal and the controller-side terminals after the compressor main body assembly and the motor controller are combined together because the working window of the terminal accommodating chamber is closed with the cover. Thereby, failures are prevented as much as possible from occurring due to dirt, oil and the like attached to the hermetic terminal and the controller-side terminals.

An eighth aspect of the present invention is the electric compressor according to any one of the 5th to 7th aspects, characterized in that the hermetic terminal and the controller-side terminals are connected together by welding.

In addition to the effects of the fifth to seventh aspects of the present invention, the eighth aspect of the present invention is capable of firmly connecting the hermetic terminal and the controller-side terminals together to achieve high reliability connection.

### BRIEF DESCRIPTION OF THE ACCOMPANYING DRAWINGS

The above and further objects and novel features of the present invention will more fully appear from the following detailed description when the same is read in conjunction with the accompanying drawings, in which:

FIG. 1 is a cross-sectional view of a conventional type of electric compressor;

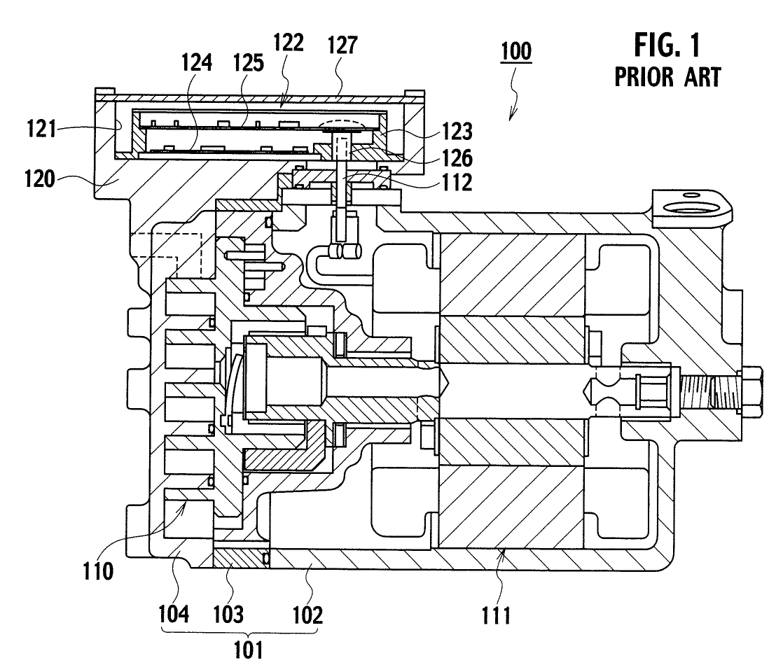

FIG. 2 shows an embodiment of the present invention, and is an exploded perspective view of an electric compressor;

FIG. 3 shows the embodiment of the present invention, and is a cross-sectional view of the electric compressor after being assembled;

FIG. 4 shows the embodiment of the present invention, and is a cross-sectional view of a compressor main body assembly and a motor controller assembly before being combined together; and

FIG. 5 shows the embodiment of the present invention, and is a plan view of a hermetic terminal and motor controller-side terminals in a terminal accommodating compartment which are viewed through a working window.

### DESCRIPTION OF THE PREFERRED EMBODIMENT

Descriptions will be provided hereinbelow for the embodiment of the present invention on the basis of the drawings.

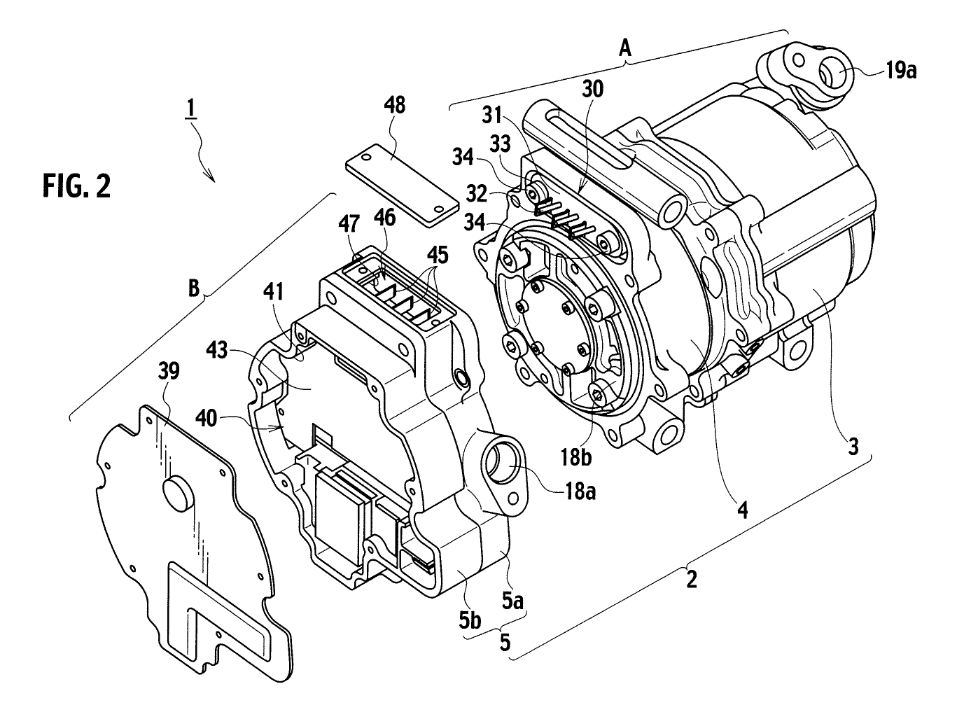

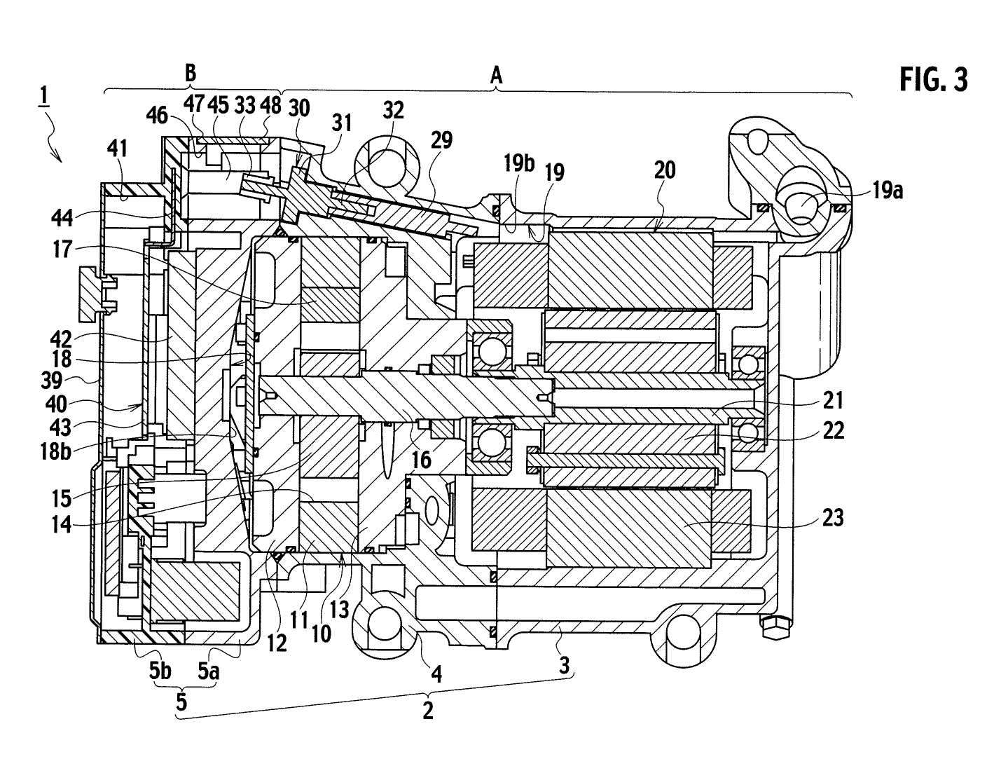

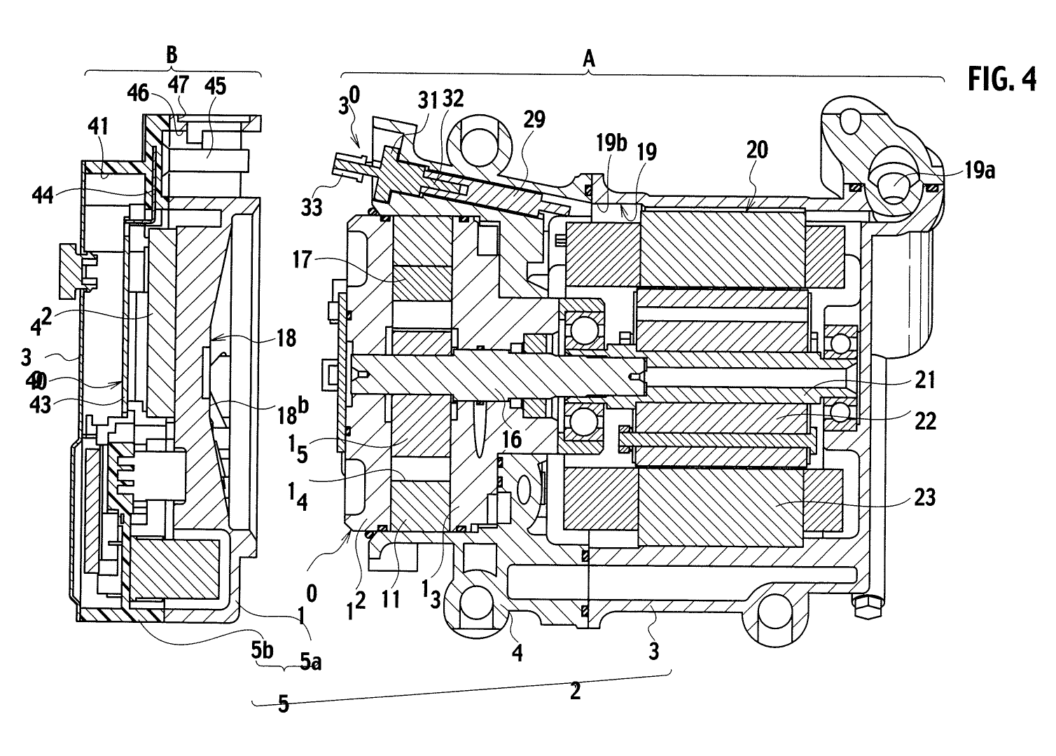

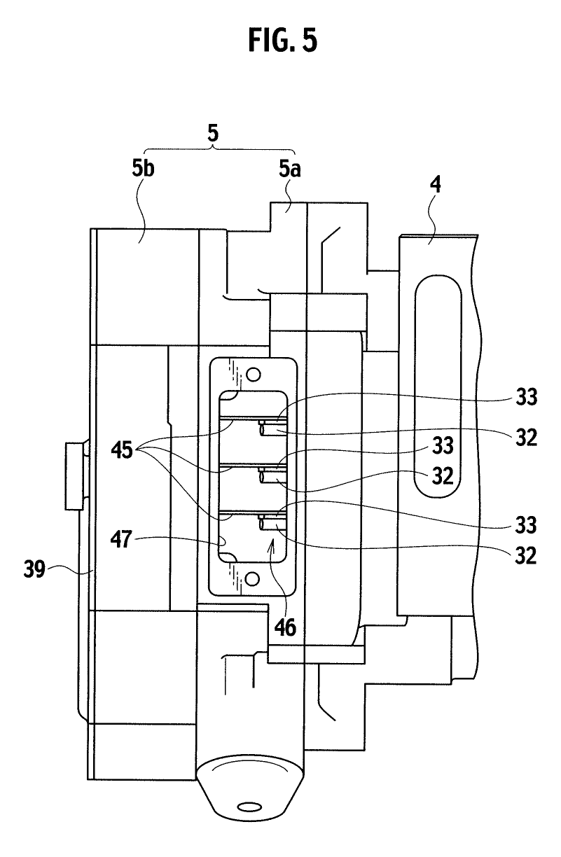

FIGS. 2 to 5 show an embodiment of the present invention. FIG. 2 is an exploded perspective view of an electric compressor. FIG. 3 is a cross-sectional view of the electric compressor after being assembled. FIG. 4 is a cross-sectional view of a compressor main body assembly and a motor controller assembly before being combined together. FIG. 5 is a plan view of a hermetic terminal and motor controller-side terminals in a terminal accommodating compartment which are viewed from a working window.

As shown in FIGS. 2 and 3, an electric compressor 1 includes a compressor main body assembly A and a motor controller assembly B. These assemblies A and B are combined together with bolts (not illustrated). The compressor main body assembly A is configured by mounting a compression mechanism 10, an electric motor 20, a connector 29, a hermetic terminal 30 and the like to a first housing member including a rear housing member 3 and a middle housing member 4. The motor controller assembly B is configured by hermetically mounting a motor controlling circuit 40 to a front housing member 5 as a second housing member.

In other words, the rear housing member 3, the middle housing member 4 and the front housing member 5 constitute a housing 2 of the electric compressor 1. The rear housing member 3 and the middle housing member 4 constitute the compressor main body assembly A, whereas the front housing member 5 constitutes the motor controller assembly B.

Next, description will be provided for a concrete configuration of the compressor main body assembly A. The rear housing member 3 is almost cylindrical in shape, with its one side surface being closed, and the other side surface being opened. The middle housing member 4 is almost cylindrical in shape, having its two end side surfaces being opened, and its one side surface being connected to the opening side of the rear housing member 3. These housing members 3, 4 are made of an aluminum alloy.

The compression mechanism 10 is accommodated in the middle housing member 4. The compression mechanism 10 includes: a cylinder block 11 in which an almost elliptic inner circumferential surface is formed; and a front side block 12 and a rear side block 13 arranged in the respective two sides of this cylinder block 11. A cylinder chamber 14 is surrounded by these blocks 11, 12, 13. Each of the blocks 11, 12, 13 is made of an aluminum alloy.

A rotor 15 is accommodated in the cylinder chamber 14. A rotary shaft 16 penetrates in the center of this rotor 15, and the rotor 15 is fixed to the rotary shaft 16. This rotary shaft 16 is rotatably supported by the front side block 12 and the rear side block 13. The rotary shaft 16 on the rear side block 13 side juts out of the rear side block 13.

Vanes 17 are provided at equal intervals in the outer periphery of the rotor 15 to be movable to retractably protrude. While the rotor 15 is rotating, each vane 17 moves being in contact with the inner wall of the cylinder chamber 14 due to backpressure and its own centrifugal force. Multiple compression chambers are formed in the cylinder chamber 14 by neighboring vanes 17. Each compression chamber alternately repeats an intake process and a compression process. In the intake process, a coolant is taken into the compression chamber by increasing the volume of the chamber depending on the rotation of the rotor 15. In a compression process, the coolant thus taken therein is compressed by reducing the volume of the chamber and subsequently discharging the coolant thus compressed. At the intake process in each compression chamber, the coolant is taken into the compression chamber in the cylinder chamber 14 through the coolant intake passage 18. At the latter half of compression process, the coolant compressed in the compression chamber in the cylinder chamber 14 is discharged through a coolant discharge passage 19. The configurations respectively of the coolant intake passage 18 and the coolant discharge passage 19 are as described later.

The electric motor 20 is accommodated in the rear housing member 3. The electric motor 20 is configured of a rotor 22 rotatably supported by the rotary shaft 21; and a stator which is located in the outer periphery of this rotor 22, and which is fixed to the inner wall of the rear housing member 3. The rotary shaft 21 of the electric motor 20 is connected to the rotary shaft 16 of the compression mechanism 10.

The connector 29 is accommodated in the middle housing member 4, and is connected to an exciting coil of the electric motor 20 with a wire.

The hermetic terminal 30 is attached to the connector 29, and is fitted to the middle housing member 4 by use of bolts 34 (shown in FIG. 2). The hermetic terminal 30 is a terminal configured to keep the inside of the middle housing member 4 hermetic, and to cause a drive signal to be supplied to the electric motor 20. The hermetic terminal 30 includes: a terminal supporting plate 31; three pin terminals 32 mounted to the terminal supporting plate 31 so as to stand upright from the terminal supporting plate 31; and weld auxiliary plates 33 welded to the respective pin terminals 32. Each pin terminal 32 juts out of the middle housing member 4. Each weld auxiliary plate 33 is a flat metal plate.

Subsequently, descriptions will be provided for a concrete configuration of the motor controller assembly B. The front housing member 5 is configured of a metal housing member 5a made of an aluminum alloy; and a resin housing member 5b which is fixed to the outside of the metal housing member 5a, and which is made of a synthetic resin.

A motor controller compartment 41 surrounded by the resin housing member 5b is formed on the outer surface side of the metal housing member 5a.

The motor controlling circuit 40 is accommodated in the motor controller compartment 41. The motor controlling circuit 40 includes: a power element 42 arranged in intimate contact with the outer surface of the metal housing member 5a; a circuit board 43 which is attached to the resin housing member 5b, and on which electronic parts are mounted; and the like. The motor controlling circuit 40 constitutes an inverter circuit. The top surface of the motor controller compartment 41 is hermetically closed with a cover 39.

Output from the inverter circuit is designed to be made through three bus bars 44 insertedly formed in resin housing member 5b. Tip portions of the respective bus bars 44 are formed as controller-side terminals 45, respectively. The three controller-side terminals 45 are accommodated in the terminal accommodating chamber 46 in the resin housing member 5b.

The side surface of the terminal accommodating chamber 46 to which the compressor main body assembly A is attached to is opened. Through this opening, the three pin terminals 32 of the hermetic terminal 30 are inserted in the terminal accommodating chamber 46 from the compressor main body assembly A. The three controller-side terminals 45 are surface-contacted to the weld auxiliary plates 33 of the three pin terminals 32, respectively. The controller-side terminals 45 are connected to the weld auxiliary plates 33 of the pin terminals 32 by welding, respectively.

The resin housing member 5b is provided with a working window 47 to let the terminal accommodating chamber 46 open to the outside. This working window 47 is used when the three controller-side terminals 45 are welded to the weld auxiliary plates 33 of the three pin terminals 32, respectively. The working window 47 is closed with a cover 48.

The coolant intake passage 18 is configured of: an intake port 18a (shown in FIG. 2) formed in the metal housing member 5a; and a coolant intake chamber 18b which causes the intake port 18a to communicate with an intake hole (not illustrated) of the compression mechanism 10. The coolant intake chamber 18b is formed of the front side block 12 of the compression mechanism 10, the metal housing member 5a of the front housing member 5, and the like. In other words, the coolant intake chamber 18b is set up only after the compressor main body assembly A and the motor controller assembly B are combined together. The coolant intake chamber 18b is formed on a side of the metal housing member 5a opposite to a side where the motor controlling circuit 40 is mounted.

The coolant discharge passage 19 is configured of: a discharge port 19a formed in the rear housing member 3; and a coolant discharge chamber 19b which causes the discharge port 19a to communicate with a discharge hole (not illustrated) of the compression mechanism 10. The coolant discharge chamber 19b is formed of the rear side block 13 of the compression mechanism 10, the rear housing member 3 and the like. The coolant discharge chamber 19b is designed to cause the coolant to pass the accommodation space of the electric motor 20 so as to be discharged.

In the foregoing configuration, after an instruction for starting the drive of the compressor is outputted to the motor controlling circuit 40, the motor controlling circuit 40 generates a predetermined three-phase alternating current from a direct current power supply, and outputs the alternating current. The three-phase alternating current thus outputted is then outputted to the electric motor 20 through the three bus bars 44, the hermetic terminal 30 and the connector 29. The electric motor 20 is driven with the three-phase alternating current. After the electric motor 20 is driven, the rotary shaft 16 of the compression mechanism 10 is rotated. Thereby, the compression mechanism 10 is driven. Then, a low-temperature and low-pressure coolant is taken into the cylinder chamber 14 in the compression mechanism 10 through the coolant intake passage 18, and is subsequently compressed in the cylinder chamber 14. By this compression, the temperature of the coolant is raised, and the pressure of the coolant is increased. Subsequently, the resultant coolant is discharged through the coolant discharge passage 19.

Next, descriptions will be provided for an assembly sequence (a manufacturing method) of the electric compressor 1. The descriptions will be provided with an assumption that the following operations have already made: the assembling operation of the compression mechanism 10; the assembling operation of the rotor 22 and the stator 23 of the electric motor 20; the assembling operation of the metal housing member 5a and the resin housing member 5b of the front housing member 5; the mounting operation of the electronic parts to the circuit board; the welding operation of the pin terminals 32 of the hermetic terminal 30 to the respective weld auxiliary plates 33.

As shown in FIG. 4, the compression mechanism 10, the electric motor 20 and the connector 29 are mounted to the rear housing member 3 and the middle housing member 4. The hermetic terminal 30 is attached to the connector 29 thus mounted thereto. In addition, the hermetic terminal 30 is fastened to the middle housing member 4 by use of the bolts 34. Thereby, the compressor main body assembly A is assembled.

The circuit board 43, the power element 42 and the like for the motor controlling circuit 40 are mounted in the motor controller compartment 41 in the front housing member 5. After all the parts are mounted therein, the cover 39 is fixed to the resin housing member 5b. Thereby, the motor controller compartment 41 is made hermetic with the cover 39. The motor controller assembly B is assembled in this manner. Only the motor controller assembly B is assembled in an environment free from dirt, oil and the like, for example, in a clean room. Accordingly, no dirt, oil or the like enters the motor controller compartment 41 during the assembling operation of the motor controller assembly B. No dirt, oil or the like enters the motor controller compartment 41 after the assembling operation of the motor controller assembly B either, because the motor controller compartment 41 is closed hermetically.

Thereafter, the compressor main body assembly A and the motor controller assembly B are combined together by use of bolts (not illustrated) with the respective combining surfaces being fitted to each other. By combining the two assemblies A, B together, the inside of the electric compressor 1 becomes hermetic. Furthermore, in the terminal accommodating chamber 46, the three controller-side terminals 45 are arranged in almost intimate contact with the weld auxiliary plates 33 of the three pin terminals 32 of the hermetic terminal 30, respectively.

Subsequently, as shown in FIG. 5, a welding instrument (not illustrated) is inserted into the terminal accommodating chamber 46 through the working window 47 to connect by welding the controller-side terminals 45 to the weld auxiliary plates 33 of the pin terminals 32, respectively. After all the welding connection is completed, potting (dehumidifier) is applied to the outer periphery of each welded spots. Thereafter, the working window 47 is covered with the cover 48.

As described above, in this embodiment, the electric compressor 1 is manufactured as follows. The compressor main body assembly A is assembled by fitting the compression mechanism 10 in the middle housing member 4 and the electric motor 20 in the rear housing member 3. The motor controller assembly B is assembled by hermetically mounting the motor controlling circuit 40 to the front housing member 5. Subsequently, the compressor main body assembly A and the motor controller assembly B are combined together.

The electric compressor 1 is manufactured in this manner. For this reason, the assembling operation of the electric compressor 1 can be made individually for the compressor main body assembly A and the motor controller assembly B. In this embodiment, the compressor main body assembly and the motor controller assembly can be separately mounted in the assembling process of the electric compressor, and dirt, oil or the like may enter the motor controller compartment only in the assembling step of the motor controller assembly. Once the motor controller assembly is assembled, the motor controller compartment is hermetically sealed so that no dirt, oil or the like can enter. For this reason, if only the motor controller assembly is assembled in an environment free from dirt, oil or the like, the dirt, oil and the like are almost completely prevented from causing failures from occurring in the motor controlling circuit. Furthermore, since components needed to assemble the motor controller assembly are the second housing member that is a part of the housing and the components of the motor controlling circuit, only these components should be transferred to an environment free from dirt, oil or the like. After being assembled, the motor controller assembly can be transferred to the assembling position of the compressor main body assembly. Thereby, the component transfer in the assembling process can be made as simple as possible, and concurrently the motor controlling circuit is almost perfectly prevented from being adversely affected by dirt, oil and the like.

Moreover, it goes without saying that this embodiment enables the performance test of the motor controlling circuit 40 not only when the electric compressor 1 is assembled, but also when the motor controller assembly B is assembled as a single unit. For this reason, this embodiment is capable of enhancing manufacturing efficiency of the electric compressor 1.

In this embodiment, the front housing member 5 is a part of the housing 2 which hermetically closes the inside of the electric compressor 1. After the compressor main body assembly A and the motor controller assembly B are assembled, the coolant intake chamber 18b is formed on a side of the front housing member 5 opposite to a side where the motor controlling circuit 40 is installed. Consequently, this embodiment is capable of cooling heat generated in the motor controlling circuit 40 by use of the coolant flowing in the coolant intake chamber 18b because the motor controlling circuit 40 is adjacent to the coolant intake chamber 18b with the front housing member 5 being interposed in between.

In this embodiment, the compressor main body assembly A is assembled from the rear housing member 3 and the middle housing member 4, and includes the hermetic terminal 30 through which the drive signal is supplied to the electric motor 20. The motor controller assembly B is assembled from the front housing member 5, and includes the controller-side terminals 45 through which the drive signal is outputted from the motor controlling circuit 40. The hermetic terminal 30 and the controller-side terminals 45 are accommodated in the front housing member 5 with the compressor main body assembly A and the motor controller assembly B being combined together. In addition, the front housing member 5 is provided with the terminal accommodating chamber 46 which is opened to the outside through the working window 47. The working window 47 is closed with the cover 48. Consequently, this embodiment can prevent the risk of dirt, oil and the like attached to the hermetic terminal 30 and the controller-side terminals 45 as much as possible while the compressor main body assembly A and the motor controller assembly B are being combined together because the hermetic terminal 30 and the controller-side terminals 45 are accommodated in the terminal accommodating chamber 46. Moreover, this embodiment is capable of perfectly eliminating the risk that dirt, oil and the like may be attached to the hermetic terminal and the controller-side terminals after the compressor main body assembly and the motor controller are combined together because the working window of the terminal accommodating chamber is closed with the cover. Thereby, failures are prevented as much as possible from occurring due to dirt, oil and the like attached to the hermetic terminal and the controller-side terminals.

In this embodiment, the hermetic terminal 30 and the controller-side terminals 45 are connected together by welding. Consequently, this embodiment is capable of firmly connecting the hermetic terminal and the controller-side terminals together to achieve high reliability connection. The hermetic terminal 30 and the controller-side terminals 45 may be connected together by crimp contact, insertion or the like.

The weld auxiliary plates 33 are provided to the respective pin terminals 32 of the hermetic terminal 30. If, however, the columnar pin terminals 32 can be connected to the respective controller-side terminals 45 securely, the weld auxiliary plates 33 are not necessarily to be provided. Moreover, if the pin terminals 32 are shaped like a flat plate, the weld auxiliary plates 33 are not necessarily to be provided.

In this embodiment, the controller-side terminals 45 are formed on the respective tip portions of the bus bars 44. However, the configuration of the controller-side terminals 45 is not limited to this.

In this embodiment, the terminal accommodating chamber 46 is provided to the front housing member 5. However, the terminal accommodating chamber 46 may be provided to the middle housing member 4.

The entire contents of Japanese Patent Application P2007-271605 (filed on Oct. 18, 2007) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. An electric compressor (1) manufacturing method, comprising the steps of:
assembling a compressor main body assembly (A) by fitting a compression mechanism (10) configured to compress a coolant and an electric motor (20) configured to drive the compression mechanism (10) to a first housing member (3, 4);
assembling a motor controller assembly (B) by mounting a motor controlling circuit (40) to a second housing member (5) so that the motor controlling circuit (40) is in a hermetic state, the motor controlling circuit (40) configured to control a drive of the electric motor (20); and
combining the compressor main body assembly (A) and the motor controller assembly (B) together.

2. The electric compressor (1) manufacturing method according to claim 1, wherein
the second housing member (5) is a component constituting a housing (2) and configured to make the inside of the compressor (1) hermetic; and
when the compressor main body assembly (A) and the motor controller assembly (B) are combined together, a coolant intake chamber (18b) is formed on a side of the second housing member (5) opposite to a side where the motor controlling circuit (40) is mounted.

3. The electric compressor (1) manufacturing method according to claim 2, wherein
in the compressor main body assembly (A) assembling step, a hermetic terminal (30) used to input a drive signal to the electric motor (20) is fitted in the first housing member (3, 4);
in the motor controller assembly (B) assembling step, a controller-side terminal (45) used to output the drive signal from the motor controlling circuit (40) are mounted to the second housing member (5);
any one of the first housing member (3, 4) and the second housing member (5) is provided with a terminal accommodating chamber (46) which is opened to the outside through a working window (47); and
when the compressor main body assembly (A) and the motor controller assembly (B) are kept to be combined together, the hermetic terminal (30) and the controller-side terminals (45) are accommodated in the terminal accommodating chamber (46) and are connected together through the working window (47), and subsequently the working window (47) is closed with a cover (48).

4. The electric compressor (1) manufacturing method according to claim 3, wherein
the hermetic terminal (30) and the controller-side terminals (45) are connected together by welding.

5. The electric compressor (1) manufacturing method according to claim 1, wherein
in the compressor main body assembly (A) assembling step, a hermetic terminal (30) used to input a drive signal to the electric motor (20) is fitted in the first housing member (3, 4);
in the motor controller assembly (B) assembling step, a controller-side terminal (45) used to output the drive signal from the motor controlling circuit (40) are mounted to the second housing member (5);
any one of the first housing member (3, 4) and the second housing member (5) is provided with a terminal accommodating chamber (46) which is opened to the outside through a working window (47); and
when the compressor main body assembly (A) and the motor controller assembly (B) are kept to be combined together, the hermetic terminal (30) and the controller-side terminals (45) are accommodated in the terminal accommodating chamber (46) and are connected together through the working window (47), and subsequently the working window (47) is closed with a cover (48).

6. The electric compressor (1) manufacturing method according to claim 5, wherein
the hermetic terminal (30) and the controller-side terminals (45) are connected together by welding.

7. An electric compressor (1) comprising:
a compressor main body assembly (A) configured by fitting a compression mechanism (10) configured to compress a coolant and an electric motor (20) configured to drive the compression mechanism (10) to a first housing member (3, 4); and
a motor controller assembly (B) configured by mounting a motor controlling circuit (40) to a second housing member (5) so that the motor controlling circuit (40) is in a hermetic state, the motor controlling circuit (40) configured to control a drive of the electric motor (20),
wherein the compressor main body assembly (A) and the motor controller assembly (B) are combined together.

8. The electric compressor (1) according to claim 7, wherein
the second housing member (5) is a component constituting a housing (2) and configured to make an inside of the electric compressor (1) hermetic; and
a coolant intake chamber (18b) is formed on a side of the second housing member (5) opposite to a side where the motor controlling circuit (40) is mounted.

9. The electric compressor (1) according to claim 8, wherein
the compressor main body assembly (A) includes a hermetic terminal (30) used to input a drive signal to the electric motor (20), and fitted in the first housing member (3, 4);
the motor controller assembly (B) includes a controller-side terminal (45) used to output the drive signal from the motor controlling circuit (40) and mounted to the second housing member (5);
any one of the first housing member (3, 4) and the second housing member (5) is provided with a terminal accommodating compartment (46) in which the hermetic terminal (30) and the controller-side terminal (45) connected together are accommodated, and which is opened to an outside through a working window (47); and
the working window (47) is closed with a cover (48).

10. The electric compressor (1) according to claim 9, wherein
the hermetic terminal (30) and the controller-side terminals (45) are connected together by welding.

11. The electric compressor (1) according to claim 7, wherein
the compressor main body assembly (A) includes a hermetic terminal (30) used to input a drive signal to the electric motor (20), and fitted in the first housing member (3, 4);
the motor controller assembly (B) includes a controller-side terminal (45) used to output the drive signal from the motor controlling circuit (40) and mounted to the second housing member (5);
any one of the first housing member (3, 4) and the second housing member (5) is provided with a terminal accommodating compartment (46) in which the hermetic terminal (30) and the controller-side terminal (45) connected together are accommodated, and which is opened to an outside through a working window (47); and
the working window (47) is closed with a cover (48).

12. The electric compressor (1) according to claim 11, wherein
the hermetic terminal (30) and the controller-side terminals (45) are connected together by welding.
